(19) United States
(12) Patent Application Publication
(10) Pub. No.: US 2015/0074473 A1
(43) Pub. Date: Mar. 12, 2015

(54) PSEUDO-ERROR GENERATING DEVICE

(71) Applicant: KABUSHIKI KAISHA TOSHIBA, Tokyo (JP)

(72) Inventor: Tsutomu UNESAKI, Tokyo (JP)

(73) Assignee: KABUSHIKI KAISHA TOSHIBA, Tokyo (JP)

(21) Appl. No.: 14/169,711

(22) Filed: Jan. 31, 2014

(30) Foreign Application Priority Data
Sep. 12, 2013 (JP) 2013-189694

(51) Int. Cl. G06F 11/22

(52) U.S. Cl. CPC G06F 11/2215
USPC 714/703

(57) ABSTRACT

A pseudo-error generating device of an embodiment includes error injection information including a header section and a data section, a storage section configured to store the error injection information, and at least one error injecting circuit, connected to a test target circuit through a predetermined path, configured to inject a pseudo-error to the predetermined path. The header section includes a port specifying one of the at least one error injecting circuit, and an address specifying the data section. The data section includes an injection condition and error injection data for injecting the pseudo-error. The error injecting circuit injects the pseudo-error to the predetermined path based on the injection condition and the error injection data.

### CROSS-REFERENCE TO RELATED APPLICATION

This application is based upon and claims the benefit of priority from the prior Japanese Patent Application No. 2013-189694 filed on Sep. 12, 2013; the entire contents of which are incorporated herein by reference.

### FIELD

Embodiment described herein relates generally to a pseudo-error generating device.

### BACKGROUND

Conventionally, a pseudo-error generating device that generates a pseudo-type error (hereinafter “pseudo-error”) and injects the same to a test target circuit such as an LSI is known. A user may check the operation of a test target circuit at the time of occurrence of an error by injecting a pseudo-error to the test target circuit by using the pseudo-error generating device. Such a pseudo-error generating device normally selects one of a plurality of points where pseudo-errors are to be generated, and injects the pseudo-error to the point.

However, the object of such a pseudo-error generating device is diagnosis of an error detection circuit (for example, an ECC circuit of a memory), and due to restrictions regarding the area of the LSI or operation frequency, circuits to which the pseudo-errors may be injected are limited to specific circuits such as a memory, and to control the timing is extremely difficult to generate a pseudo-error. Accordingly, with the conventional pseudo-error generating device, the operation of a system at the time of injection of a pseudo-error cannot be sufficiently checked.

Also, to control the timing of generation of a pseudo-error, and to sufficiently check the operation at the time of injection of the pseudo-error, software has to be changed or hardware has to be stopped, for example, and the operation of the system is affected.

Furthermore, with the conventional pseudo-error generating device, the conditions for injecting a pseudo-error are fixed, or the types of pseudo-errors to be injected are fixed, and injecting pseudo-errors to a test target circuit are very restricted.

### BRIEF DESCRIPTION OF THE DRAWINGS

FIG. 1 is a diagram showing a configuration of a pseudo-error generating system including a pseudo-error generating device according to a present embodiment;

FIG. 2 is a diagram for describing a data structure of error injection information 4;

FIG. 3 is a diagram for describing a configuration of a status section;

FIG. 4 is a diagram for describing an example of another configuration of an error generating circuit 6;

FIG. 5 is a diagram for describing an example of another configuration of the error generating circuit 6;

FIG. 6 is a diagram for describing a connection relationship of an error injecting circuit 15 and a test target circuit 7; and

FIG. 7 is a diagram for describing a detailed configuration of the error injecting circuit 15.

### DETAILED DESCRIPTION

A pseudo-error generating device of an embodiment includes error injection information which includes a header section and a data section, a storage section configured to store the error injection information, and at least one error injecting circuit, connected to a test target circuit through a predetermined path, configured to inject a pseudo-error to the predetermined path. The header section includes a port specifying one of the at least one error injecting circuit, and an address specifying the data section. The data section includes an injection condition and error injection data for injecting the pseudo-error. The error injecting circuit injects the pseudo-error error to the predetermined path based on the injection condition and the error injection data.

In the following, an embodiment of the present invention will be described in detail with reference to the drawings.

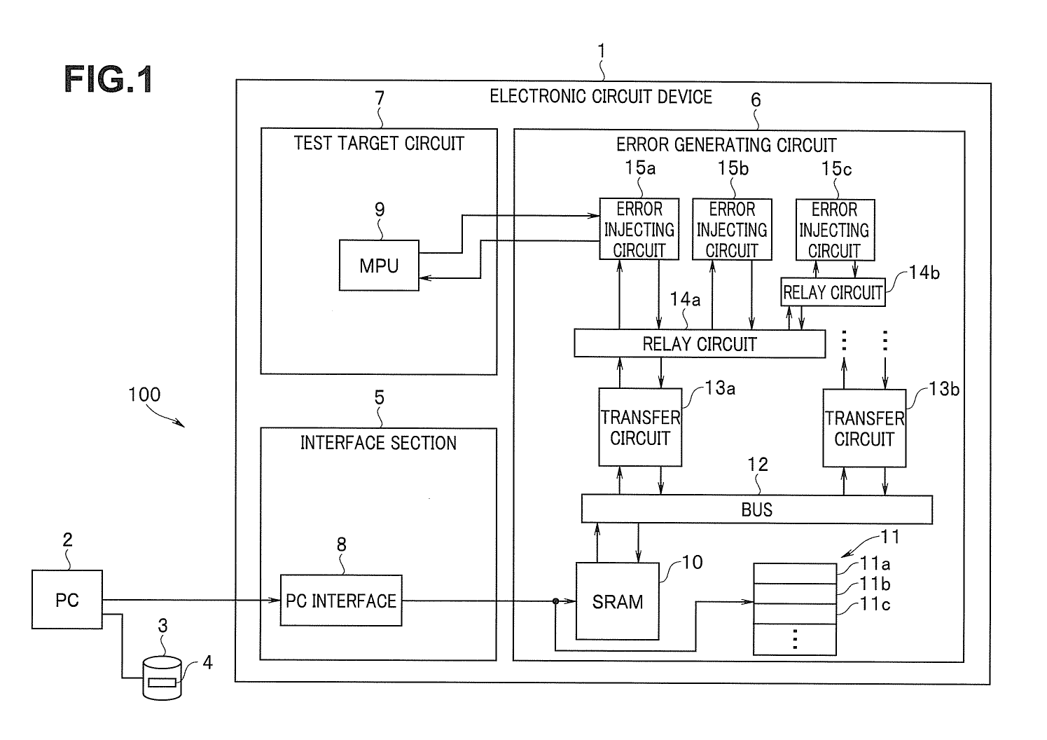

FIG. 1 is a diagram showing a configuration of a pseudo-error generating system 100 including a pseudo-error generating device according to a present embodiment.

The pseudo-error generating system 100 includes an electronic circuit device 1, a personal computer (hereinafter “PC”) 2 connected to the electronic circuit device 1, and a storage device 3 connected to the PC 2. Error injection information 4 describing information for injecting a pseudo-error is stored in the storage device 3.

The electronic circuit device 1 is configured from an FPGA (field programmable gate array) capable of reconfiguring the configuration of a circuit, and includes an interface section 5, an error generating circuit 6, and a test target circuit 7. The interface section 5 includes a PC interface 8 connected to the PC 2, and the test target circuit 7 includes an MPU 9.

The error generating circuit 6 as the pseudo-error generating device includes an SRAM 10, a register section 11 configured by a plurality of registers 11a, 11b, 11c, . . . , a bus 12, at least one (two in the example in FIG. 1) of transfer circuits 13a and 13b, at least one (two in the example in FIG. 1) of relay circuits 14a and 14b, and at least one (three in the example in FIG. 1) of error injecting circuits 15a, 15b and 15c. In the following description, in the case of referring to one of or all the circuits, the circuit(s) is/are simply referred to as the transfer circuit(s) 13, the relay circuit(s) 14 or the error injecting circuit(s) 15.

When a user operates the PC 2, the error injection information 4 stored in the storage device 3 is read and is transmitted to the electronic circuit device 1. The error injection information 4 which has been transmitted is stored in the SRAM 10 as the storage section of the error generating circuit 6 via the PC interface 8. The error generating circuit 6 generates a pseudo-error based on the error injection information 4 stored, and injects the pseudo-error to the MPU 9. Furthermore, the error generating circuit 6 stores an execution result of injection of the pseudo-error in a predetermined area of the SRAM 10.

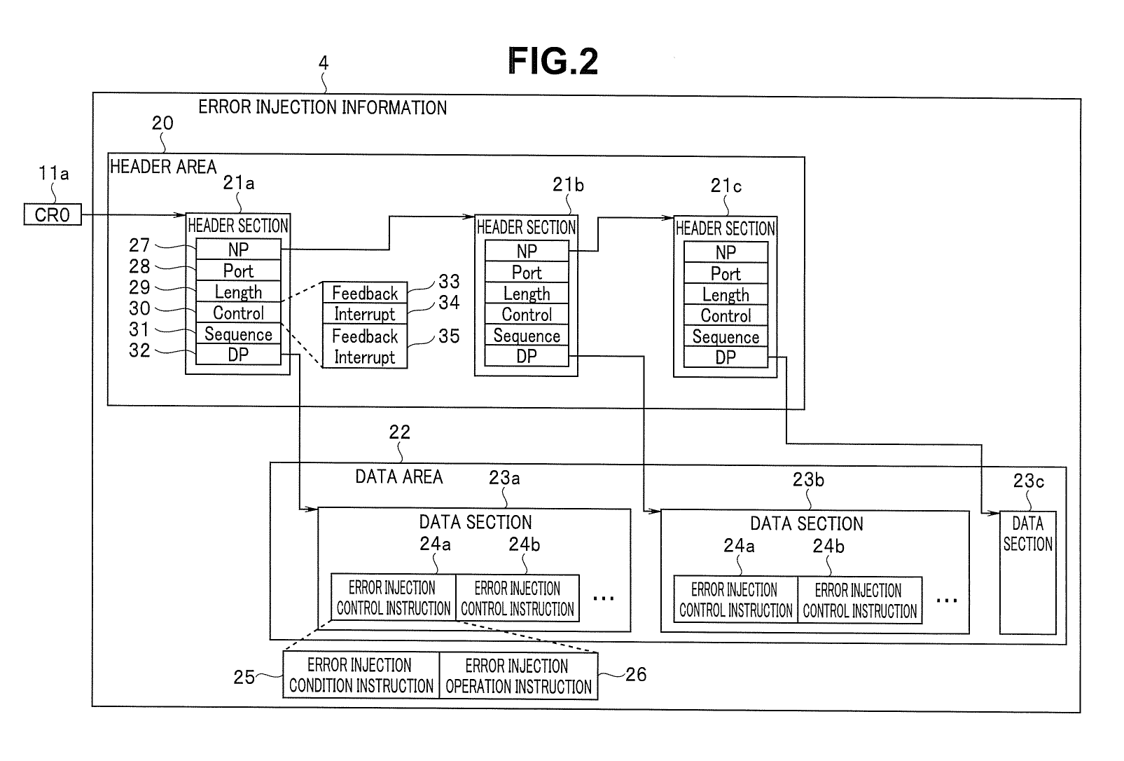

Here, a data structure of the error injection information 4 in FIG. 2 will be described.

The error injection information 4 is configured from a header area 20 including at least one (three in the example in FIG. 2) of header sections 21a, 21b and 21c, and a data area 22 including at least one (three in the example in FIG. 2) of data sections 23a, 23b and 23c. The data sections 23a, 23b and 23c are associated with the header sections 21a, 21b and 21c, respectively. In the following description, in the case of referring to one of or all the sections, the section(s) is/are simply referred to as the header section(s) 21 or the data section(s) 23. In the present embodiment, one header section 21a and one data section 23a associated with the header section 21a are called a descriptor. That is, the error injection information 4 is configured from one or more descriptors present in a chain manner (or in a circular-buffer mariner).

Each data section 23 includes at least one (two in the example in FIG. 2) of error injection control instructions 24a and 24b. In the following description, in the case of referring to one of or all the error injection control instructions, the error injection control instruction(s) is/are simply referred to as the error injection control instruction(s) 24. Each error injection control instruction 24 is a smallest unit to be processed by the error injecting circuit 15, and is configured from an error injection condition instruction 25, and an error injection operation instruction 26.

Each header section 21 is configured from an NP field 27, a Port field 28, a Length field 29, a Control field 30, a Sequence field 31, and a DP field 32. The Control field 30 is configured from a Feedback field 33, an Interrupt field 34, and a Feedback Interrupt field 35.

The NP field 27 stores information for specifying a pointer to a next descriptor. If the bit of the NP field 27 is 0, it is indicated that there is no next descriptor. In the example in FIG. 2, the bit of the NP field of the header section 21c is 0. The information indicating the pointer to a first descriptor is stored in the register 11a, for example.

The Port field 28 stores information for specifying a port number of the error injecting circuit 15. The Port field 28 is referred to, and then, the descriptor is transferred to one of the error injecting circuits 15.

The Length field 29 stores information indicating the number of transfer bytes of the data section 23.

The Sequence field 31 stores information indicating the number of a sequence to be restored in the status section (a predetermined area of the SRAM 10).

The DP field 32 stores information for specifying a pointer to a corresponding data section 23. For example, the DP field 32 of the header section 21a stores information for specifying the pointer to the corresponding data section 23a.

The Feedback field 33 of the Control field 30 stores information for updating the status section. For example, at the time of updating the status section, the bit of the Feedback field 33 becomes 1. The Interrupt field 34 stores information for generating an interrupt when transfer of the corresponding data section 23 is completed. Also, the Feedback Interrupt field 35 stores information for generating an interrupt at the time of update of the status section (and requires the Feedback field 33 being 1). Such error injection information 4 is input to the transfer circuit 13 via the bus 12.

The transfer circuit 13 reads the descriptor (the header section 21 and the data section 23) in the error injection information 4 which has been input, and transfers the descriptor to the error injecting circuit 15 via the relay circuit 14. At this time, the transfer circuits 13a and 13b refer to the Port field 28 specifying the port number of the error injecting circuit 15 included in the header section 21, and transfer the descriptor to the error injecting circuit 15 specified. That is, if the port number of the error injecting circuit 15c is specified in the Port field 28, the transfer circuit 13a transfers the descriptor to the error injecting circuit 15c via the relay circuits 14a and 14b.

The relay circuit 14 includes one upper port, and at least one (for example, maximum four) lower port, and transfers a descriptor transferred from the upper port to one of the lower ports. The upper port is on the transfer circuit 13 side, and the lower port is on the error injecting circuit 15 side. In the example in FIG. 1, the relay circuit 14a includes one upper port connected to the transfer circuit 13a, and three lower ports connected to the relay circuit 14b, and the error injecting circuits 15a and 15b.

Also, the relay circuit 14 transfers status information (an execution result of injection of a pseudo-error) transferred from the lower port, to the upper port. That is, the status information transferred from the error injecting circuit 15a to the relay circuit 14a is transferred to the transfer circuit 13a, which is the upper port. The transfer circuit 13a transfers the status information to the SRAM 10 via the bus 12. The status information is stored in the status section provided in the SRAM 10.

The error injecting circuit 15 is connected to the MPU 9. Note that, in FIG. 1, only the error injecting circuit 15a is connected to the MPU 9, but the error injecting circuits 15b and 15c are also connected to the MPU 9. The error injecting circuit 15 monitors a signal from the MPU 9 based on the descriptor which has been transferred, and if a predetermined condition is satisfied, injects a pseudo-error to the MPU 9. Then, the error injecting circuit 15 transfers the status information, which is the execution result of injection of the pseudo-error, to the transfer circuit 13 via the relay circuit 14.

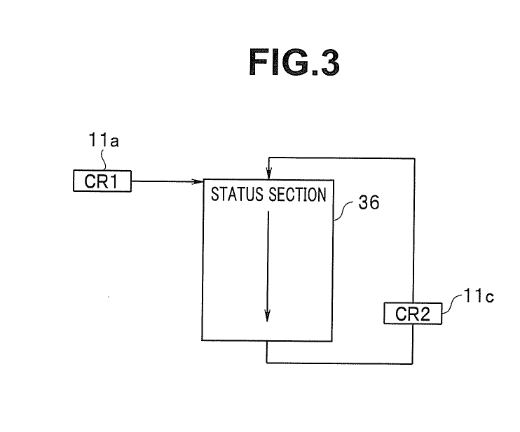

Now, the configuration of the status section in FIG. 3 will be described.

The status section 36 is an area for storing the status information, which is the execution result of injection of a pseudo-error. The status information consists mainly of a Port field where information of the port number of the error injecting circuit 15 which has injected the pseudo-error is stored, a Status field where information such as the type of injected pseudo-error or the like is stored, a Sequence field where information of the number of sequence to be restored in the status section 36 is stored, and a Timestamp field where time information is stored. The Sequence field stores information of the Sequence field 31 of the header section 21.

The status section 36 is secured in the SRAM 10 for each transfer circuit 13. That is, at least one status section 36 is secured in the SRAM 10 according to the number of the transfer circuits 13.

A beginning address of the status section 36 secured in the SRAM 10 is stored in the register 11b, for example, and the size of the status section 36 is stored in the register 11c, for example. Note that, if two or more status sections 36 are secured in the SRAM 10, information of the beginning addresses and the sizes are stored in other registers of the register section 11.

At the time of transferring the status information from the error injecting circuit 15 and updating the status section 36, if an update address in the status information reaches a last address of the status section 36, the operation is stopped, or update is continued by returning to the beginning of the status section 36, that is, the status information is overwritten.

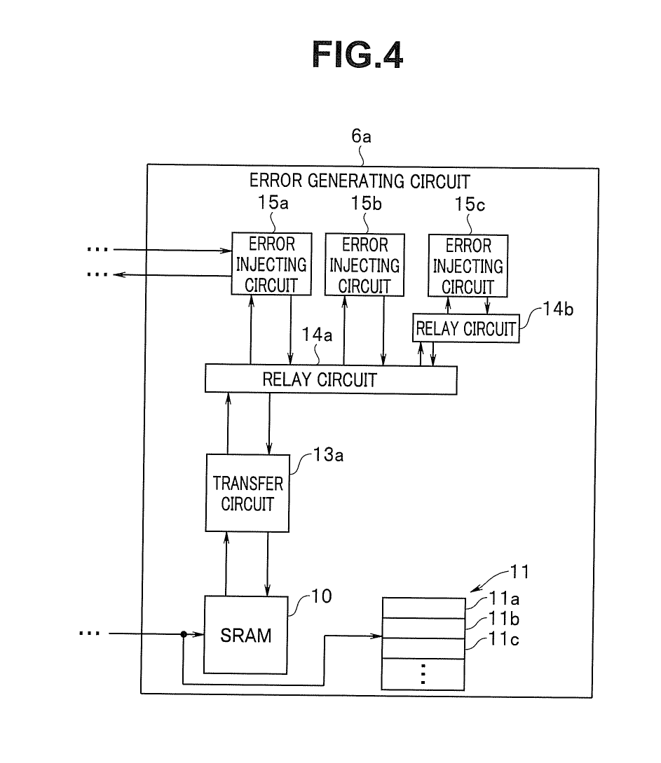

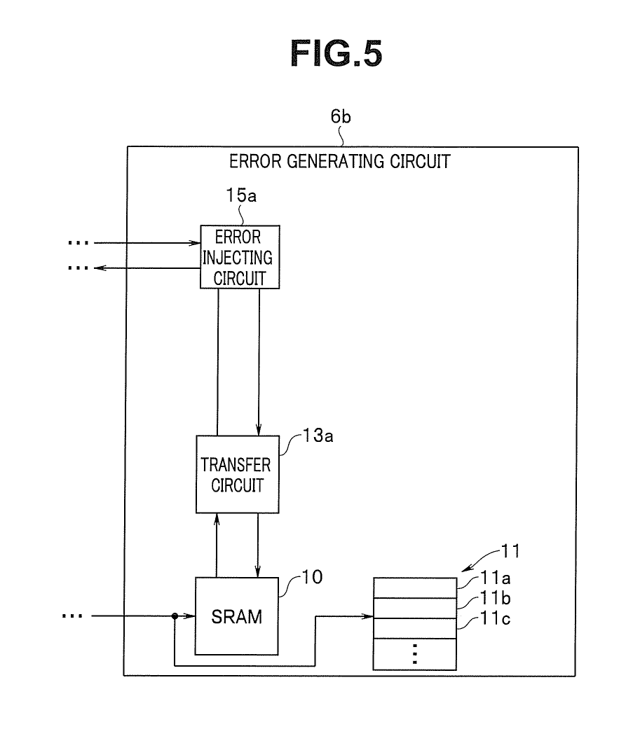

Note that the error generating circuit 6 is not restricted to the configuration in FIG. 1. FIGS. 4 and 5 are diagrams for describing examples of other configurations of the error generating circuit 6.

In contrast to the error generating circuit 6 in FIG. 1, an error generating circuit 6a in FIG. 4 is configured from one transfer circuit 13a. If there is one transfer circuit 13a, as in this case, the bus 12 in FIG. 1 does not have to be provided. That is, the SRAM 10 and the transfer circuit 13a are directly connected. In this case, the transfer circuit 13a reads a descriptor of the error injection information 4 stored in the SRAM 10, and transfers the descriptor to the error injecting circuit 15 via the relay circuit 14.

Also, in contrast to the error generating circuit 6a in FIG. 4, an error generating circuit 6b in FIG. 5 is configured from one error injecting circuit 15a. If there is one error injecting circuit 15a, as in this case, the relay circuit 14 in FIG. 4 does not have to be provided. That is, the transfer circuit 13a and the error injecting circuit 15a are directly connected. In this case, the transfer circuit 13a reads a descriptor of the error injection information 4 stored in the SRAM 10, and transfers the descriptor to the error injecting circuit 15a.

Note that configurations are also possible according to which the SRAM 10 in FIGS. 1, 4 and 5 respectively is provided to the PC 2. In this case, the error injection information 4 read from the storage device 3 is stored in the SRAM 10 provided to the PC 2. Then, the error injection information 4 is transferred to the PC interface 8, the bus 12 and the transfer circuit 13, and is transferred to the error injecting circuit 15 specified by the error injection information 4 via the relay circuit 14.

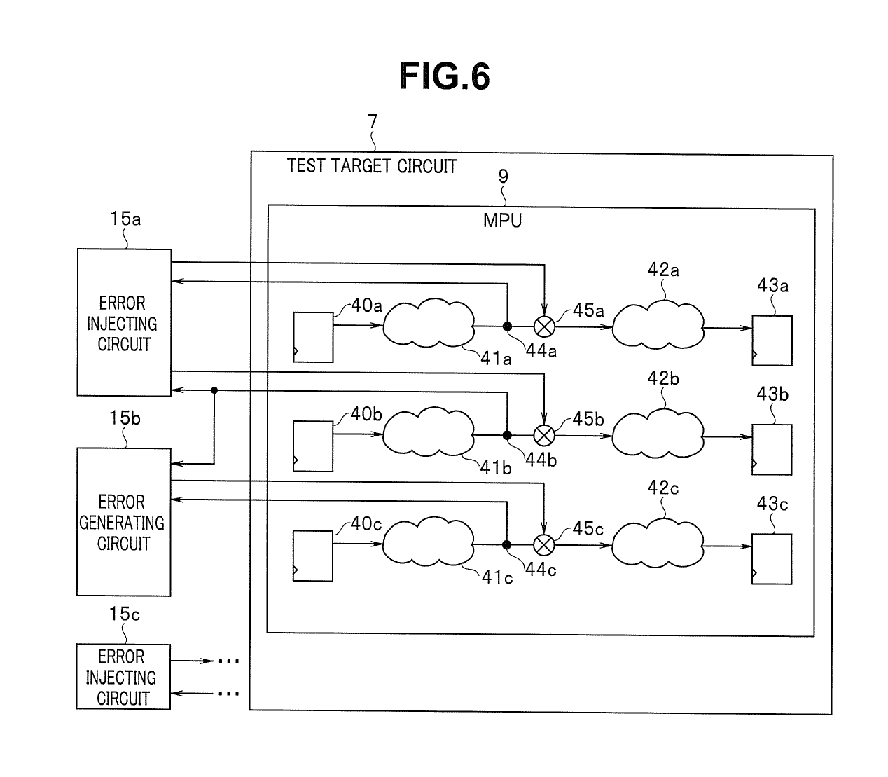

Next, a connection relationship of the error injecting circuit 15 and the test target circuit 7 will be described. FIG. 6 is a diagram for describing a connection relationship of the error injecting circuit 15 and the test target circuit 7.

The MPU 9 of the test target circuit 7 includes a plurality of flip-flops (hereinafter “FF”) 40a to 40c and 43a to 43c, and a plurality of combinational circuits 41a to 41c and 42a to 42c. Note that an input port or an output port may be used instead of the flip-flop, for example.

An output of the FF 40a is connected to an input of the combinational circuit 41a. Also, an output of the combinational circuit 41a is connected to an input of the combinational circuit 42a, and an output of the combinational circuit 42a is connected to an input of the FF 43a. Moreover, a signal monitoring point 44a and an error injection point 45a are provided between the combinational circuits 41a and 42a. Note that the configuration of the combinational circuit is arbitrary, and the positions of the signal monitoring point and the error injection point are also arbitrary.

In the same manner, the FF 40b, the combinational circuit 41b, the combinational circuit 42b and the FF 43b are connected, and the FF 40c, the combinational circuit 41c, the combinational circuit 42c and the FF 43c are connected. The signal monitoring point 44b and the error injection point 45b are provided between the combinational circuits 41b and 42b, and the signal monitoring point 44c and the error injection point 45c are provided between the combinational circuits 41 c and 42c. Note that, in the following description, in the case of referring to one of or all of the points, the point(s) is/are simply referred to as the signal monitoring point(s) 44 or the error injection point(s) 45.

The error injecting circuit 15a monitors a signal at the signal monitoring point 44a (an output signal from the combinational circuit 41a), and injects a pseudo-error to the error injection point 45a. Also, the error injecting circuit 15a monitors a signal at the signal monitoring point 44b (an output signal from the combinational circuit 41b), and injects a pseudo-error to the error injection point 45b.

Note that the relationships of the signal monitoring points 44a and 44b with the error injection points 45a and 45b are not restricted to the relationships described above. For example, the error injecting circuit 15a may monitor a signal at the signal monitoring point 44b and inject a pseudo-error to the error injection point 45a, or monitor a signal at the signal monitoring point 44a and inject a pseudo-error to the error injection point 45b. Or, the error injecting circuit 15a may monitor a signal at the signal monitoring point 44a or 44b, and inject a pseudo-error to the error injection points 45a and 45b at the same time.

Also, the error injecting circuit 15b monitors a signal at the signal monitoring point 44b and a signal at the signal monitoring point 44c (an output signal from the combinational circuit 41c), and injects a pseudo-error to the error injection point 45c.

In this manner, the error injecting circuit 15 may monitor a signal at one or more signal monitoring points 44, and inject a pseudo-error to one or more error injection points 45.

Note that, although not shown in the drawing, the error injecting circuit 15c may also monitor a signal from the MPU 9, and inject a pseudo-error to one or more error injection points, not shown, as with the error injecting circuits 15a and 15b.

In the present embodiment, the electronic circuit device 1 is configured from an FPGA, and thus, the signal monitoring point and the error injection point may be easily added or changed.

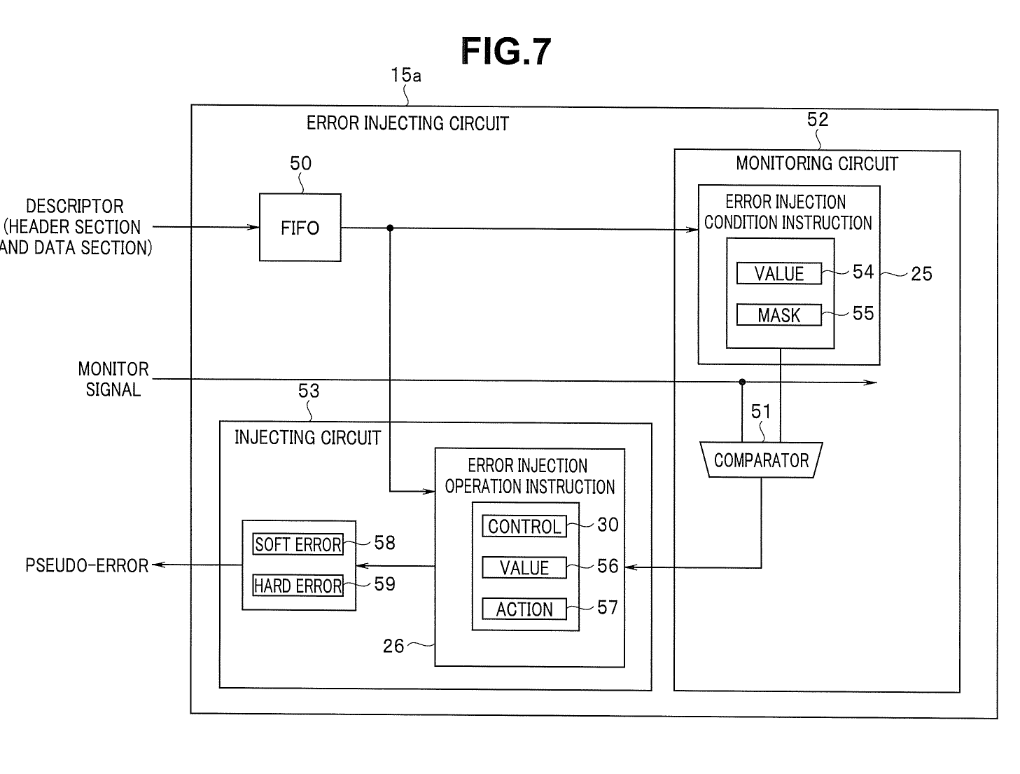

Now, a detailed configuration of the error injecting circuit 15 in FIG. 7 will be described.

The error injecting circuit 15 is configured from a FIFO 50, a monitoring circuit 52 including a comparator 51, and an injecting circuit 53. A descriptor (the header section 21 and the data section 23) is held in the FIFO 50. Moreover, an error injection condition instruction 25 included in an error injection control instruction 24 of the data section 23 is input to the monitoring circuit 52, and an error injection operation instruction 26 is input to the injecting circuit 53. Furthermore, the Control field 30 of the header section 21 is input to the injecting circuit 53 as a part of the error injection operation instruction 26.

The error injection condition instruction 25 includes a VALUE field 54 and a MASK field 55 where a pseudo-error injection condition is stored. The VALUE field 54 stores data (a value) to be compared with a monitor signal, and the MASK field 55 stores data for masking the monitor signal. For example, monitor signals of a plurality of signal monitoring points 44a and 44b are input to the error injecting circuit 15a in FIG. 6. Accordingly, the MASK field 55 stores information for masking the monitor signal of the signal monitoring point 44b at the time of comparing the monitor signal of the signal monitoring point 44a with the value in the VALUE field 54.

Information from the VALUE field 54 and the MASK field 55 (the pseudo error injection condition) and the monitor signal of the signal monitoring point 44 are input to the comparator 51. The comparator 51 determines whether the pseudo-error injection condition and the monitor signal match, and outputs the determination result to the injecting circuit 53. More specifically, the comparator 51 determines whether a result of a logical AND of the monitor signal of the signal monitoring point 44 and the MASK field 55 and a result of a logical AND of the VALUE field 54 and the MASK field 55 match, and outputs the determination result to the injecting circuit 53.

The error injection operation instruction 26 of the injecting circuit 53 includes a VALUE field 56 and an ACTION field 57. The VALUE field 56 stores data for injecting a pseudo-error, and the ACTION field 57 stores information about the type of pseudo-error to be injected. The type of pseudo-error is a soft error 58, a hard error 59, and the like. For example, the ACTION field 57 stores information such as injection, as the soft error 58, of an inverted value of the value of a monitor signal or 0 or 1 with respect to only the bit where 1 is specified among the bits of the VALUE field 56, injection of the value of the VALUE field 56 as the soft error, injection, as the hard error, of an inverted value of the value of a monitor signal or 0 or 1 with respect to only the bit where 1 is specified among the bits of the VALUE field 56, and injection of the value of the VALUE field 56 as the hard error.

The soft error 58 is injection of the pseudo-error to the error injection point 45 only in one cycle of a clock of the error injecting circuit 15. Also, the hard error 59 is permanent injection of the pseudo-error to the error injection point 45. Note that the hard error 59 may include transient or intermittent errors in addition to permanent errors. With respect to a transient error, a hard error is injected to an FF or a memory, update of the injected part is monitored, and then, the hard error is cleared. Also, with respect to an intermittent error, a hard error is injected, and then, the hard error is cleared by using a timer or the like.

If a determination result that the pseudo-error injection condition and a monitor signal match is input, the injecting circuit 53 injects a pseudo-error to the error injection point 45 according to the information in the VALUE field 56 and the ACTION field 57. Also, at the time of injecting a pseudo-error, the injecting circuit 53 generates status information based on the information in the Control field 30 and transfers the status information to the status section 36 of the SRAM 10.

If a plurality of error injection control instructions 24a, 24b, . . . are included, the error injecting circuit 15 executes the first error injection control instruction 24a and then discards the error injection control instruction 24a, and reads the next error injection control instruction 24b from the FIFO 50 and performs determination regarding the injection condition and injection of the pseudo-error.

Next, an operation of the pseudo-error generating device of the present embodiment will be described.

When a user operates the PC, and the error injection information 4 stored in the storage device is read and transmitted to the electronic circuit device 1, the error injection information 4 is transmitted to the SRAM 10 via the PC interface 8. At this time, an address of a first descriptor of the error injection information 4 is written in the register 11a.

When the address is written in the register 11a, the transfer circuit 13 starts DMA, for example, and the descriptor (the header section 21 and the data section 23) of the error injection information 4 is transferred to the transfer circuit 13 via the bus 12. The transfer circuit 13 refers to the Port field 28 of the header section 21, and transfers the descriptor to the error injecting circuit 15 specified by the Port field 28 via the relay circuit 14. The error injecting circuit 15 injects a pseudo-error to the test target circuit 7 according to the error injection control instruction 24 of the data section 23.

At this time, the monitoring circuit 52 of the error injecting circuit 15 monitors a signal from the test target circuit 7 according to the VALUE field 54 and the MASK field 55 of the error injection condition instruction 25. Then, if the monitor signal is determined to match the injection condition at the monitoring circuit 52, the injecting circuit 53 of the error injecting circuit 15 injects a pseudo-error to the test target circuit 7 according to the VALUE field 56 and the ACTION field 57 of the error injection operation instruction 26.

The injecting circuit 53 of the error injecting circuit 15 transfers an execution result (status information) of injection of the pseudo-error to the transfer circuit 13 via the relay circuit 14, according to the Control field 30 of the error injection operation instruction 26. The transfer circuit 13 stores the status information which has been transferred from the error injecting circuit 15 in the status section 36 of the SRAM 10.

The status information stored in the status section 36 may be transmitted to the PC 2 via the PC interface 8. The user may check the status information by a display device, not shown, connected to the PC 2, and check the operation at the time of injection of the pseudo-error.

As described above, the error generating circuit 6 as the pseudo-error generating device refers, at the transfer circuit 13, to the header section 21 of the descriptor of the error injection information 4 transferred from the SRAM 10, and transfers the descriptor to the specified error injecting circuit 15. The error generating circuit 6 monitors, at the error injecting circuit 15, a signal according to the error injection condition instruction 25 of the descriptor.

Furthermore, if the monitor signal is determined at the error injecting circuit 15 to match the injection condition, the error generating circuit 6 injects a pseudo-error to the test target circuit 7 according to the error injection operation instruction 26. As a result, the error generating circuit 6 may inject a pseudo-error of an arbitrary type to the MPU 9 at an arbitrary timing and under an arbitrary condition.

Accordingly, with the pseudo-error generating device of the present embodiment, a pseudo-error may be freely injected to a test target circuit.

While certain embodiments have been described, these embodiments have been presented by way of example only, and are not intended to limit the scope of the inventions. Indeed, the novel apparatuses, methods and circuits described herein may be embodied in a variety of other forms; furthermore, various omissions, substitutions and changes in the form of the apparatuses, methods and circuits described herein may be made without departing from the spirit of the inventions. The accompanying claims and their equivalents are intended to cover such forms or modifications as would fall within the scope and spirit of the inventions.

What is claimed is:

1. A pseudo-error generating device comprising:
error injection information including a header section and a data section;
a storage section configured to store the error injection information; and
at least one error injecting circuit, connected to a test target circuit through a predetermined path, configured to inject a pseudo-error to the predetermined path,
wherein the header section includes a port specifying one of the at least one error injecting circuit, and an address specifying the data section,
wherein the data section includes an injection condition and error injection data for injecting the pseudo-error, and
wherein the error injecting circuit injects the pseudo-error to the predetermined path based on the injection condition and the error injection data.

2. The pseudo-error generating device according to claim 1,
wherein the error injecting circuit includes
a monitoring circuit configured to monitor a signal from the test target circuit, to determine whether the signal being monitored matches the injection condition, and to output a determination result, and
an injecting circuit configured to generate data of the pseudo-error based on the error injection data if a determination result indicating that the signal being monitored matches the injection condition is input from the monitoring circuit, and to inject the generated data of pseudo-error to the predetermined path.

3. The pseudo-error generating device according to claim 2, wherein the monitoring circuit includes a comparator configured to compare the signal from the test target circuit with the injection condition.

4. The pseudo-error generating device according to claim 2, wherein the injection condition is configured from data to be compared with the signal from the test target circuit and data for masking the signal from the test target circuit.

5. The pseudo-error generating device according to claim 1, wherein the error injection data is configured from data for injecting the pseudo-error and information about a type of the pseudo-error to be injected.

6. The pseudo-error generating device according to claim 5, wherein the type of the pseudo-error includes a soft error of injecting the pseudo-error only in one cycle of a clock of the error injecting circuit, and a hard error of permanently injecting the pseudo-error.

7. The pseudo-error generating device according to claim 1, comprising:
a transfer circuit configured to analyze the port of the header section of the error injection information stored in the storage section, and to transfer the header section and the data section to the error injecting circuit that is specified.

8. The pseudo-error generating device according to claim 7, comprising:
a relay circuit, provided between the transfer circuit and the at least one error injecting circuit, configured to relay the header section and the data section transferred from the transfer circuit to the error injecting circuit that is specified.

9. The pseudo-error generating device according to claim 1, wherein the storage section includes a status section configured to store status information that is an execution result of injecting the pseudo-error.

10. The pseudo-error generating device according to claim 9, wherein the error injecting circuit stores the status information in the status section after injecting the pseudo-error to the predetermined path.
